(19) United States
(12) Patent Application Publication
(10) Pub. No.: US 2009/0114784 A1
(43) Pub. Date: May 7, 2009

(54) FUEL TANK MOUNTING ARRANGEMENT AND METHOD OF MOUNTING A FUEL TANK

(76) Inventor: Dennis Tam, Macungie, PA (US)

Correspondence Address: WRB-IP LLP, 1217 KING STREET, ALEXANDRIA, VA, 22314, US

(21) Appl. No.: 12/300,650

(22) PCT Filed: May 17, 2006
(86) PCT No.: PCT/US06/18958

§ 371 Date: Nov. 13, 2008

(51) Int. Cl. A47B 96/06; F16L 3/00

(52) U.S. Cl. 248/205.1; 24/115 R

(57) ABSTRACT

A fuel tank mounting arrangement includes a bracket arrangement adapted to be mounted to a vehicle frame rail and a strap. The strap is supported relative to the vehicle frame rail by the bracket arrangement. The strap is adapted to extend around substantially an entire circumference of at least one generally circularly cylindrical fuel tank. A method of mounting a fuel tank is also disclosed.

### BACKGROUND AND SUMMARY

The present invention relates to a fuel tank mounting arrangement and method and, more particularly, to a fuel tank mounting arrangement and method wherein a strap extends around substantially an entire circumference of a fuel tank.

Cylindrical fuel tanks for vehicles such as trucks are often mounted to the vehicle frame by straps. Conventional mounting assemblies have straps that wrap around approximately 180 to 270 degrees of the tank circumference in order to pull the tank toward/secure the tank relative to a bracket. Trying to tighten the straps around the tank can result in denting of the tank from uneven application of force. Additionally, tanks tend to rotate in the mounting straps, largely as the result of vibration from an operating truck.

It is desirable to provide a mounting arrangement and method that can reduce the possibility of denting of a tank during mounting with a strap. It is also desirable to provide a mounting arrangement and method that can reduce the possibility of rotation of a tank relative to a vehicle.

According to an aspect of the present invention, a fuel tank mounting arrangement comprises a bracket arrangement adapted to be mounted to a vehicle frame rail and a strap. The strap is supported relative to the vehicle frame rail by the bracket arrangement. The strap is adapted to extend around substantially an entire circumference of at least one generally circularly cylindrical fuel tank.

According to another aspect of the present invention, a method of mounting a fuel tank relative to a vehicle comprises positioning at least one generally circularly cylindrical fuel tank relative to a mounting bracket arrangement adapted to be mounted to a vehicle frame rail and extending a strap substantially 360° around the fuel tank and at least part of the bracket arrangement so that the fuel tank is supported relative to the part of the bracket arrangement by the strap.

### BRIEF DESCRIPTION OF THE DRAWINGS

The features and advantages of the present invention are well understood by reading the following detailed description in conjunction with the drawings in which like numerals indicate similar elements and in which:

FIGS. 1A and 1B are front perspective and top views, respectively, of a fuel tank mounting arrangement according to an embodiment of the present invention, and FIG. 1C is a front perspective, exploded view of a fuel tank mounting arrangement (without fuel tank illustrated) according to the embodiment illustrated in FIGS. 1A and 1B;

FIGS. 2A-2C are side, schematic views showing a strap connected to a bracket arrangement according to embodiments of the present invention by fastening the strap to the bracket arrangement, by wrapping the strap around the bracket arrangement, and by threading the strap through openings in the bracket arrangement, respectively;

FIGS. 3A-3C are side, rear, and top views of a strap and bracket arrangement according to embodiments of the present invention, and FIG. 3D is a perspective view of a frame bracket according to an embodiment of the present invention; and

FIG. 4 shows a step in a method of mounting a fuel tank to a vehicle according to embodiments of the present invention.

### DETAILED DESCRIPTION

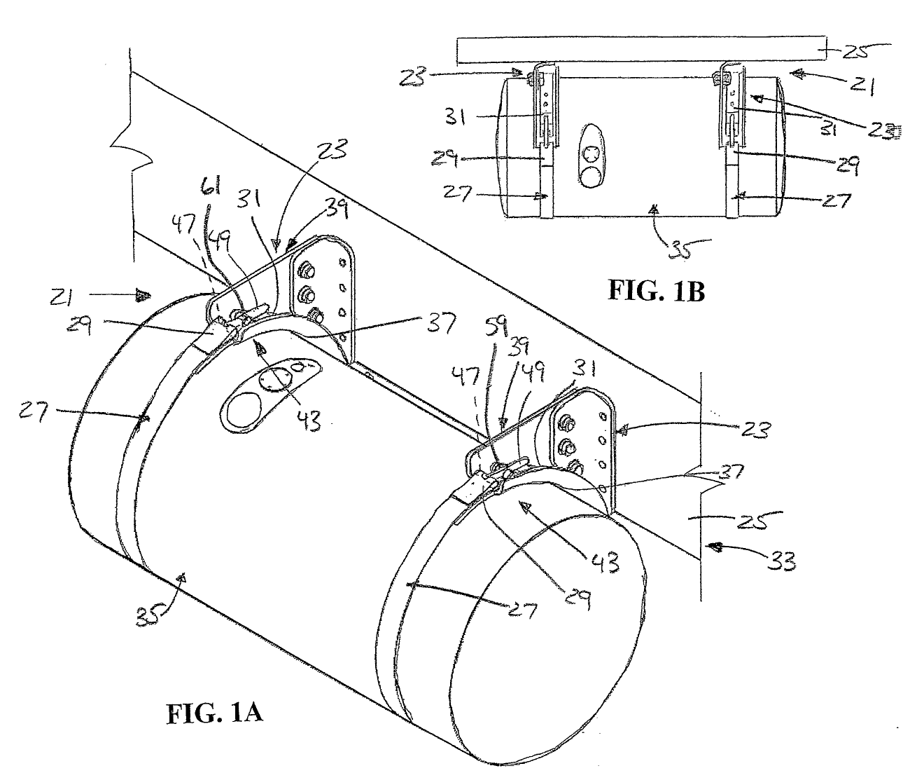

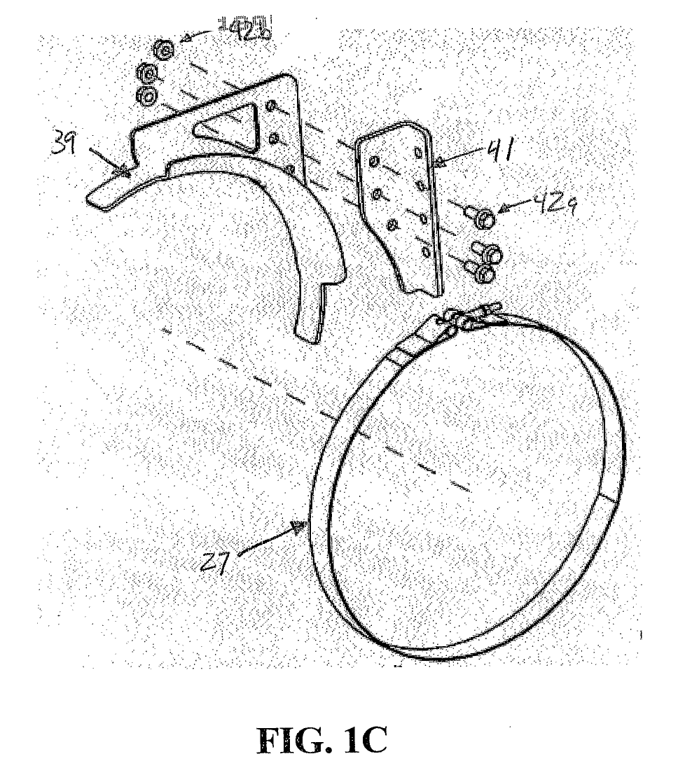

A fuel tank mounting arrangement 21 according to an embodiment of the present invention is shown in FIGS. 1A-1B. The fuel tank mounting arrangement 21 comprises a bracket arrangement 23 adapted to be mounted to a vehicle frame rail 25. The fuel tank mounting arrangement 21 further comprises a strap 27. The strap 27 may be endless but, in the illustrated embodiments, the strap has a first end 29 and a second end 31 that are adapted to be connected to each other. The strap 27 is supported relative to the vehicle 33 by the bracket arrangement 23. The strap 27 is adapted to extend around substantially an entire circumference of at least one generally circularly cylindrical fuel tank 35. The present invention is not limited to use with fuel tanks that are exactly circular in cross-section.

The phrase “substantially an entire circumference of the fuel tank” is used to clarify that the strap 27 does not necessarily extend around 100% of the circumference. For example, in the embodiment illustrated in FIG. 1A, the strap 27 extends around about 98% of the circumference, and a portion of a link 43 bridges the gap between ends of the strap. The strap 27 may extend around more or less than 98% of the tank 35 and will be considered to extend around substantially an entire circumference of the tank. By providing a substantially complete wrap of the strap 27 around the tank 35, a uniform pressure is applied to the tank, unlike in conventional arrangements where the strap extends around only about 180 to 270 degrees of the tank circumference. This arrangement can provide substantial frictional forces between the straps 27 and tank 35 to avoid rotation of the tank in the straps. In addition, by wrapping the strap 27 around the entire circumference of the tank 35, forces on the tank from the strap can be more evenly distributed than when the strap only wraps around a portion of the tank.

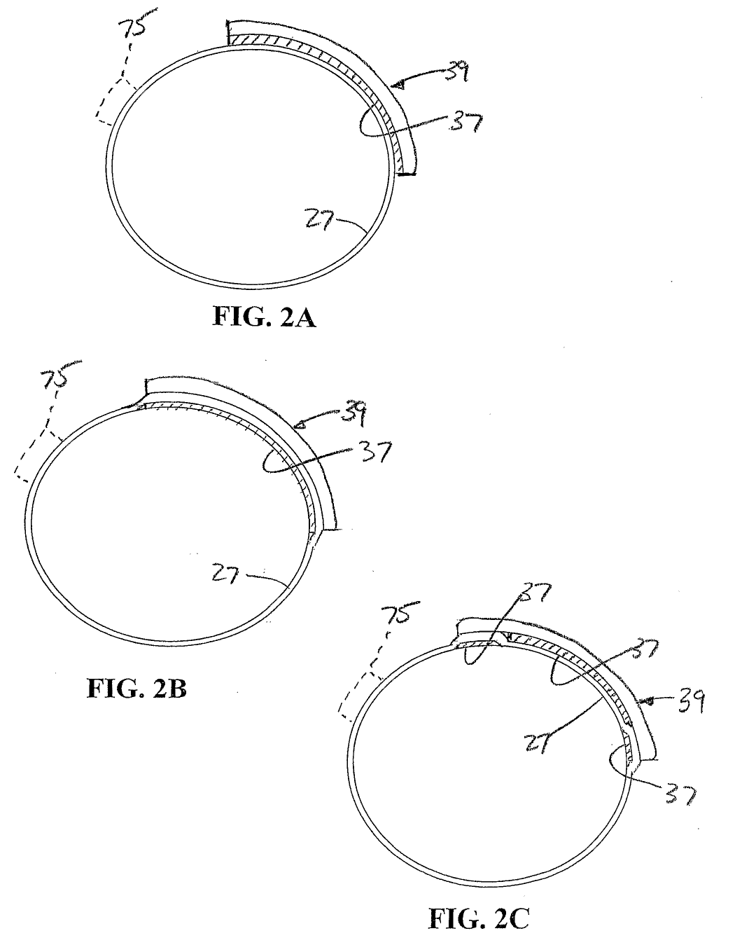

The strap 27 may be connected to part of the bracket arrangement 23 by being fastened to the bracket arrangement by any suitable means, such as by brazing or welding, by adhesives, or by mechanical fasteners (FIG. 2A) such as bolts, rivets, and the like. Alternatively, the strap 27 may be connected to the part of the bracket arrangement 23 by merely contacting the part of the bracket arrangement, such as by being wrapped around the part of the bracket arrangement (as seen in FIG. 2B) and, prior to being fastened in place around the fuel tank, merely having a loose contact with the part of the bracket arrangement. Similarly, the strap 27 may be threaded through openings (as seen in FIG. 2C) in the bracket arrangement 23 so that the strap is in contact with the bracket arrangement.

The strap 27 may be in direct contact with the part of the bracket arrangement 23. Alternatively, some intermediate object, such as a shock absorbing pad, can be provided between the strap 27 and the part of the bracket arrangement 23. For purposes of the present application, this form of indirect contact between the strap 27 and the bracket arrangement 23 shall be considered to constitute “contact” between the strap and the bracket arrangement.

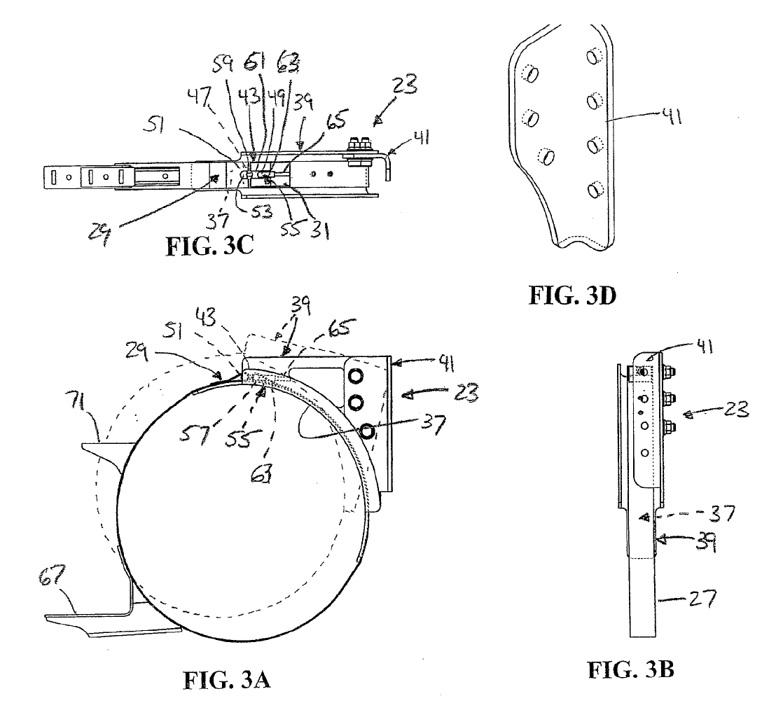

As seem in FIG. 3A, the bracket arrangement 23 comprises a generally semi-circular shaped surface 37 against which the fuel tank 35 is adapted to abut, either directly or with the strap 27 between the surface and the fuel tank, or both directly in some areas and with the strap 27 between the surface and the fuel tank, such as when the strap is threaded through openings in the semi-circular surface. The semi-circular surface 37 has a radius at least as large as a radius of the circularly cylindrical fuel tank 35 against which it is intended to abut. In this way, frictional contact between the fuel tank 35 and the strap 27 or the strap together with the semi-circular surface 37 can be provided for substantially 360° around the fuel tank. This substantially 360° contact can reduce any tendency that the fuel tank 35 may have to rotate relative to the strap 27, the bracket arrangement 23, and the vehicle 33.

The bracket arrangement 23 can be a one-piece structure, however, it may be desirable to provide the bracket arrangement as a multi-piece structure. For example, the semi-circular surface 37 can be part of a saddle bracket portion 39 of the bracket arrangement 23. As seen in FIGS. 3A-3C, the saddle bracket portion 39 can, in turn, be attached to a frame bracket portion 41 of the bracket arrangement 23, such as by bolts 42a and nuts 42b (FIG. 1C), and the frame bracket portion can be mounted to the vehicle frame rail 25. An embodiment of the frame bracket 41 is shown without the saddle bracket 39 in FIG. 3D.

The saddle bracket 39 can be removably attached to the frame bracket 41, such as by being secured by bolts, or can be fixedly attached to the frame bracket, such as by welding. Moreover, the same or substantially the same saddle bracket 39 can be fixedly or removably attachable to the same or substantially the same frame bracket 41 at a plurality of different angles. In this way, as seen partially in phantom in FIG. 3A, a fuel tank 35 can be held by the strap 27 in cantilever fashion on the saddle bracket 39 at different elevations relative to the ground, as desired. The saddle bracket 39 shown in, e.g., FIG. 1A extends around approximately 90 degrees of the circumference of the tank 35, however, it will be appreciated that the saddle bracket may extend around a substantially greater or lesser portion of the circumference of the tank, including more than 180 degrees.

As seen in FIG. 1, a link 43 can be provided for connecting the first end 29 and the second end 31 of the strap 27. In the illustrated embodiment, the link 43 includes a first portion 45 that may be generally “T” shaped, and comprises a top portion 47 retained at the first end 29 of the strap 27 and a leg portion 49 extending from the top portion toward the second end 31 of the strap. The top portion 47 may be retained in any suitable fashion, such as by being secured in a loop 51 formed at the first end 29 of the strap 27, with the leg portion 49 extending through a hole 53 provided in the loop.

A second portion 55 of the link 43 can be at least partially retained at the second end 31 of the strap 27, such as in a loop 57 with a hole 59 through which the leg 49 can extend. The second portion 55 can comprise an opening 61 for receiving the leg portion, such as a ring with two arms extending radially in opposite directions from the ring, the arms being retained by the loop 57 and the opening of the ring aligning with the hole 59 in the loop. The leg 49 can extend through the opening 61 and the hole 59 and a fastener such as a nut 63 can be threaded onto a threaded end portion 65 of the leg to fasten the leg portion of the first portion 45 in the opening 61 of the second portion 55 and thereby connect the first and second ends 29 and 31 of the strap 27. It will be appreciated that any number of well-known alternative connection structures can be used instead of the link 43 described here.

A variety of different components can be attached to the strap 27, including one or more of a step bracket 67 (FIG. 3A), a treadplate bracket 71 (FIG. 3A), a fairing bracket (not shown), and a crossover bracket (not shown) of the type used for securing multiple tanks 35 to the vehicle frame rail 25. The components may be attached to the strap in any suitable fashion, such as by brazing or welding, by adhesives, or by mechanical fasteners such as bolts, rivets, and the like. Another of the various possible ways that the components may be attached to the strap 27 is by threading the strap being through openings in the components so that, when the strap is placed around the fuel tank 35 and tensioned, the components will be held in place relative to the strap by friction between the component and the strap and possibly the tank or some other structure.

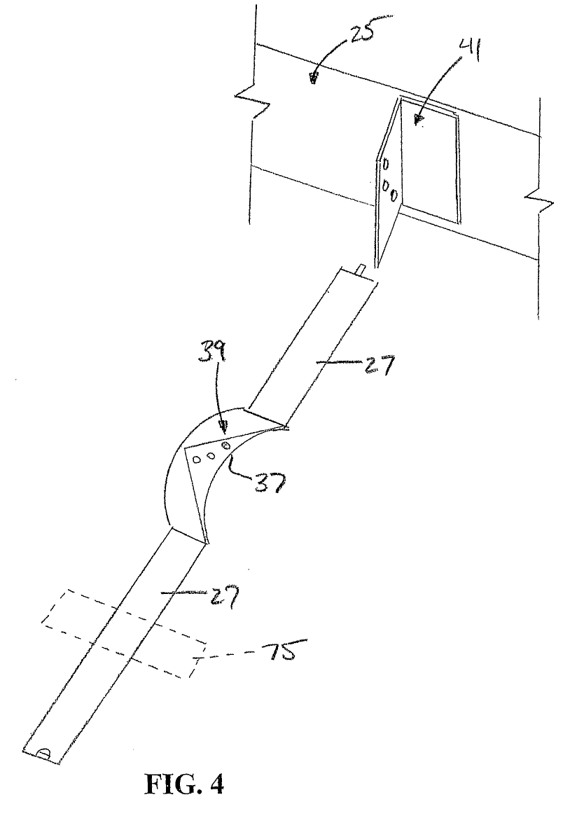

FIG. 4 shows part of a method of mounting a fuel tank 35 relative to a vehicle 33. According to the method, a fuel tank (not shown in FIG. 4) is positioned relative to at least part of the bracket arrangement 23, i.e., relative to at least the saddle bracket 39. As seen in FIG. 3A, the strap 27 is extended substantially 360° around the fuel tank so that the fuel tank is supported relative to the part of the bracket arrangement by the strap. As described in connection with FIGS. 2A-2B, the strap 27 can be secured around the fuel tank, around the fuel tank and part of the bracket 23, or around the fuel tank and the bracket 23. First and second ends 29 and 31 of the strap can be connected in any suitable manner, such as by a link 43. It will be appreciated that the strap can be secured in other ways, such as by providing an endless strap and providing a means for taking up slack in the strap, such as by using a clamp to clamp the slack in a loop.

As seen in FIG. 4, prior to extending the strap 27 around the fuel tank 35, the strap can be laid out flat. In this position, one or more modular components 75 such as the step bracket 57, the fairing bracket, the treadplate bracket 71, and/or the crossover bracket can be connected to the strap 27. In addition, the saddle bracket 39 can be connected to the strap 27 prior to connecting the saddle bracket to the frame bracket 41.

If the components 75 are properly fixed in place on the strap 27, the strap and the components can then be secured around the fuel tank 35 and the components can be in their proper position relative to the fuel tank. Of course, the components 75 can be held in place relative to the fuel tank 35 by friction, in which case it may be necessary to adjust the position of the components in the course of securing the strap 27 around the fuel tank. Components 75 can be held in place relative to the tank 35 in any suitable manner, such as by fastening the components to the strap 27 (e.g., welding, brazing, fasteners, etc.), or such as by wrapping the strap around some portion of the component so it is held in place relative to the fuel tank by friction, similar to the manner in which FIGS. 2B and 2C show the strap and the bracket arrangement 23.

Prior to or subsequent to mounting the saddle bracket 39 to the frame bracket 41, a position of the saddle bracket can be adjusted relative to the frame bracket, such as is seen in FIG. 3A. By appropriate adjustment of the relative positions of the saddle bracket 39 and the frame bracket 41, the height of the fuel tank 35 can be adjusted relative to the vehicle frame rail 25.

It will be appreciated that, with a multi-piece bracket arrangement 23 including a frame bracket 41 and a saddle bracket 39, as well as a separate strap 27, a variety of assembly possibilities are available. For example, the frame bracket 41 and the saddle bracket 39 can be attached to each other, and the strap 27 can extend around the fuel tank 35 and the saddle bracket 39, and the entire assembly—frame bracket, saddle bracket, strap, and fuel tank 35—can then be attached to the truck frame rail 25. Another possibility is that the frame bracket 41 can be mounted to the vehicle frame rail 25 and the strap 27 can be extended around the fuel tank 35 and the saddle bracket and, subsequently, the saddle bracket can be attached to the frame bracket as seen in FIG. 4. Still another possibility is that the saddle bracket 39 and the frame bracket 41 can be attached to one another and to the vehicle frame rail 25 prior to extending the strap 27 around the fuel tank 35 and the saddle bracket. It will be appreciated that other permutations are possible, and the foregoing examples are illustrative, not restrictive.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A fuel tank mounting arrangement, comprising:
a bracket arrangement adapted to be mounted to a vehicle frame rail; and
a strap, the strap being supported relative to the vehicle frame rail by the bracket arrangement, the strap being adapted to extend around substantially an entire circumference of at least one generally circularly cylindrical fuel tank.

2. The fuel tank mounting arrangement as set forth in claim 1, wherein the strap is connected to part of the bracket arrangement by being fastened to the bracket arrangement.

3. The fuel tank mounting arrangement as set forth in claim 1, wherein the strap is connected to part of the bracket arrangement by contacting part of the bracket arrangement.

4. The fuel tank mounting arrangement as set forth in claim 3, wherein the strap directly contacts part of the bracket arrangement.

5. The fuel tank mounting arrangement as set forth in claim 1, wherein the bracket arrangement comprises a generally semi-circular surface against which the fuel tank is adapted to abut, the semi-circular surface having a radius at least as large as a radius of the fuel tank.

6. The fuel tank mounting arrangement as set forth in claim 5, wherein the strap is connected to the bracket by extending around at least part of the semi-circular surface.

7. The fuel tank mounting arrangement as set forth in claim 6, wherein the strap is fastened to the semi-circular surface.

8. The fuel tank mounting arrangement as set forth in claim 5, wherein the semi-circular surface is part of a saddle bracket portion of the bracket arrangement, the saddle bracket portion being adapted to be attached to a frame bracket portion, the frame bracket portion being adapted to be mounted to the vehicle frame rail.

9. The fuel tank mounting arrangement as set forth in claim 1, wherein the strap has a first end and a second end, the first end being connectable to the second end.

10. The fuel tank mounting arrangement as set forth in claim 1, further comprising a link for connecting the first end and the second end of the strap.

11. The fuel tank mounting arrangement as set forth in claim 10, wherein the link includes a first portion comprising a top portion retained at the first end of the strap and a leg portion extending from the top portion toward the second end of the strap.

12. The fuel tank mounting arrangement as set forth in claim 11, wherein the link comprises a second portion at least partially retained at the second end of the strap, the second portion comprising an opening for receiving the leg portion, the link comprising a fastener for fastening the leg portion of the first portion in the opening of the second portion:

13. The fuel tank mounting arrangement as set forth in claim 1, comprising one or more of a step bracket, a fairing bracket, a crossover bracket, and a treadplate bracket attached to the strap.

14. The fuel tank mounting arrangement as set forth in claim 1, wherein the bracket arrangement comprises a frame bracket adapted to be mounted on the vehicle frame rail and a saddle bracket attached to the frame bracket.

15. The fuel tank mounting arrangement as set forth in claim 14, wherein the saddle bracket is removably attached to the frame bracket.

16. The fuel tank mounting arrangement as set forth in claim 15, wherein the saddle bracket is attachable to the frame bracket at a plurality of different angles.

17. The fuel tank mounting arrangement as set forth in claim 14, wherein the saddle bracket has a semi-circular surface against which the circularly cylindrical fuel tank is adapted to abut, the semi-circular surface having a radius at least as large as a radius of the circularly cylindrical fuel tank.

18. A method of mounting a fuel tank relative to a vehicle, comprising:
positioning at least one generally circularly cylindrical fuel tank relative to a mounting bracket arrangement adapted to be mounted to a vehicle frame rail; and
extending a strap substantially 360° around the fuel tank and at least part of the bracket arrangement so that the fuel tank is supported relative to the part of the bracket arrangement by the strap.

19. The method of mounting a fuel tank relative to a vehicle as set forth in claim 18, comprising securing the strap around the fuel tank and the part of the bracket by connecting first and second ends of the strap.

20. The method of mounting a fuel tank relative to a vehicle as set forth in claim 18, comprising attaching one or more of a step bracket, a fairing bracket, a crossover bracket, and a treadplate bracket to the strap prior to extending the strap around the fuel and the part of the bracket.

21. The method of mounting a fuel tank relative to a vehicle as set forth in claim 18, comprising mounting a vehicle contacting portion of the bracket arrangement to the vehicle frame rail and adjusting a position of a fuel tank contacting portion of the bracket arrangement relative to the vehicle contacting portion of the bracket arrangement so as to adjust a height of the fuel tank relative to the vehicle frame rail.

22. The method of mounting a fuel tank relative to a vehicle as set forth in claim 18, comprising mounting a vehicle contacting portion of the bracket arrangement to the vehicle frame rail and extending the strap around the fuel tank and a fuel tank contacting portion of the bracket arrangement and, subsequently, attaching the fuel tank contacting portion of the bracket arrangement relative to the vehicle contacting portion of the bracket arrangement.
